(19) United States
(12) Patent Application Publication
(10) Pub. No.: US 2025/0109846 A1
(43) Pub. Date: Apr. 3, 2025

(54) INTEGRATED INFRARED SENSING DEVICE FOR CONTROLLING LIGHT SOURCE AND USING METHOD THEREOF

(71) Applicant: Xia Li, Meishan (CN)

(72) Inventor: Xia Li, Meishan (CN)

(21) Appl. No.: 18/373,971

(22) Filed: Sep. 28, 2023

(51) Int. Cl. F21V 23/04; F21W 131/103; H05B 47/11; H05B 47/195

(52) U.S. Cl. CPC F21V 23/0464; H05B 47/11; H05B 47/195; F21W 2131/103

(57) ABSTRACT

The invention discloses an integrated infrared sensing device for controlling a light source and a using method thereof. The integrated infrared sensing device comprises a housing and a mounting base arranged in the housing, wherein a sensitivity adjusting key, at least one infrared sensing probe and a control circuit board are arranged on the mounting base, the infrared sensing probes enable 360-degree sensing of humans or objects, the sensitivity adjusting key can adjust the sensing distance of the infrared sensing probe, and the control circuit board controls the on/off of the light source after receiving a sensing signal from the infrared sensing probe.

### BACKGROUND OF THE INVENTION

### 1. Technical Field

The invention relates to the technical field of infrared sensing, in particular to an integrated infrared sensing device for controlling a light source and a using method thereof.

### 2. Description of Related Art

The majority of current streetlights use light sensors for on/off control of a light source. These streetlights automatically turn on in the dark, consistently emitting light regardless of whether there are people around or not, leading to a waste of electricity.

In order to conserve electricity, an existing sensor streetlight is equipped with an infrared sensor on a light pole. The infrared sensor controls the on/off of the light source by detecting the presence of human beings or moving objects. The infrared sensor on the light pole has a sensing capability within a specific area or angle and can detect one or multiple persons within the sensing range, allowing for regulation of the lighting of the streetlight. An example of such a technology can be found in the US patent with the publication number US20190215935A1.

However, the patent has the following problems: first, there is only one infrared human body sensing probe on the streetlight, allowing sensing within a limited angle and incapable of achieving 360-degree coverage; second, the sensing distance of the infrared sensing probe on the light pole is fixed and non-adjustable, so the streetlight with this structure cannot adequately serve the needs of users; and third, the brightness of the light source on the existing streetlight is generally fixed, lacking the capability to be adjusted according to user preferences.

Based on the above problems, it is necessary to provide a novel infrared sensing device, which enables 360-degree sensing of humans or objects, and allows adjustable sensing distance of an infrared sensing probe as well as brightness control of a light source, effectively meeting the diverse requirements of users.

### BRIEF SUMMARY OF THE INVENTION

The invention provides an integrated infrared sensing device for controlling a light source, comprising a housing and a mounting base arranged in the housing, wherein
a plurality of through holes are formed in the housing, a sensitivity adjusting key and at least one infrared sensing probe are arranged on the mounting base, and the sensitivity adjusting key and the infrared sensing probe are able to extend out of the through holes;
a control circuit board electrically connected with the sensitivity adjusting key and the infrared sensing probe is also arranged in the housing;
the infrared sensing probes enable 360-degree sensing of humans or objects;
the sensitivity adjusting key is able to adjust the sensing distance of the infrared sensing probe; and
the control circuit board controls the on/off of the light source after receiving a sensing signal from the infrared sensing probe.

The invention further provides an integrated infrared sensing device for controlling a light source, comprising a housing, wherein
at least three infrared sensing probes and a sensitivity adjusting key are arranged on the housing, and a control circuit board electrically connected with the infrared sensing probes and the sensitivity adjusting key is arranged in the housing;
the infrared sensing probes enable 360-degree sensing of humans or objects;
the sensitivity adjusting key is able to adjust the sensing distance of the infrared sensing probe; and
the control circuit board controls the on/off of the light source after receiving a sensing signal from the infrared sensing probe.

The invention provides a using method of an integrated infrared sensing device for controlling a light source, comprising:
providing an integrated infrared sensing device for controlling a light source, the integrated infrared sensing device comprising a housing, three infrared sensing probes, a sensitivity adjusting key, a brightness adjusting key and a mode control key being arranged on the housing, and an external connecting part being arranged at a top of the housing;
wherein the infrared sensing probes enable 360-degree sensing of human activity within a sensing distance, and when there is human activity, the infrared sensing probes control the light source to emit light through electrical signals, otherwise, the light source is in a standby state; and
the using method further comprises:
fixing the integrated infrared sensing device on a sensing lamp through the external connecting part;
adjusting the sensing distance of the infrared sensing probes through the sensitivity adjusting key; and
making the light source work in different brightness modes through the brightness adjusting key.

### BRIEF DESCRIPTION OF THE SEVERAL VIEWS OF THE DRAWINGS

In order to explain the technical scheme of the application more clearly, the drawings used in the embodiments will be briefly introduced below. Obviously, the drawings in the following description are only some embodiments of the application, and for those of ordinary skill in the field, other drawings can be obtained according to these drawings without paying creative labor.

FIG. 1 is a diagram of an overall structure of the invention;

FIG. 2 is a structural diagram of a housing;

FIG. 3 is a diagram showing the positions of various components on the housing;

FIG. 4 is a structural diagram of the inside and top of a housing;

FIG. 5 is a structural diagram of a ring;

FIG. 6 is a diagram of a cavity in a housing;

FIG. 7 is a structural view of a mounting base;

FIG. 8 is a diagram showing the positions of each adjusting key and protrusion;

FIG. 9 is a diagram showing the position of a control circuit board;

FIG. 10 is a flow chart of a using method of the invention;

FIG. 11 is a workflow chart of the invention in a test mode;

FIG. 12 is a workflow chart of the invention in an AUTO mode; and

FIG. 13 is a workflow chart of the invention in a Dusk To Dawn mode.

Included in the drawings:

1000. integrated infrared sensing device, 2000. housing, 2100. housing body, 2110, external connecting part, 2130. through holes, 2140. connecting block, 2150. cavity, 2200. mounting base, 2210. protrusion, 2211. fourth protrusion, 2220. opening, 2230. set screw, 2240. bottom surface, 2250. outer wall, 2260. wire hole, 2300. ring, 2310. screw hole, 2320. screw, 3100. sensitivity adjusting key, 3200. infrared sensing probe, 3300. brightness adjusting key, 3400. mode control key, 3500. control circuit board, 4000. housing, 4100. housing body, 4110. through hole, 4200. mounting base, 4210. protrusion, 4211. opening, 5100. infrared sensing probe, 5200. sensitivity adjusting key, 5300. control circuit board, 5400. mode control key, 5500. ring.

### DETAILED DESCRIPTION OF THE INVENTION

Various aspects and features of some embodiments have been summarized above, and the following detailed description will further illustrate several exemplary embodiments so that those skilled in the art can practice these embodiments. Embodiments of the inventive concept will now be described in detail, examples of which are illustrated in the accompanying drawings. The drawings are not necessarily drawn to scale. The described examples are for illustrative purposes only and are not intended to limit the scope of the invention. However, it should be understood that one of ordinary skill in the art may practice the inventive concept without these specific details.

It should be understood that although the terms first, second, etc. may be used herein to describe various elements, these elements should not be limited by these terms. These terms are only used to distinguish one element from another. For example, the first accessory can be referred to as the second accessory, and similarly, the second accessory can also be referred to as the first accessory, without departing from the scope of the inventive concept.

It will be understood that when an element or layer is referred to as “on”, “coupled to” or “connected to” another element or layer, it can be directly on, coupled to or connected to another element or layer, or there may be intervening elements or layers. Conversely, when an element is said to be “directly on”, “directly coupled to” or “directly connected to” another element or layer, there is no intervening element or layer.

Like numerals refer to like elements. As used herein, the terms “and/or” include any and all combinations of one or more related listed items. The singular forms “a”, “an” and “the” used in the description of the inventive concept and the appended Claims also include plural forms, unless the context clearly indicates other forms.

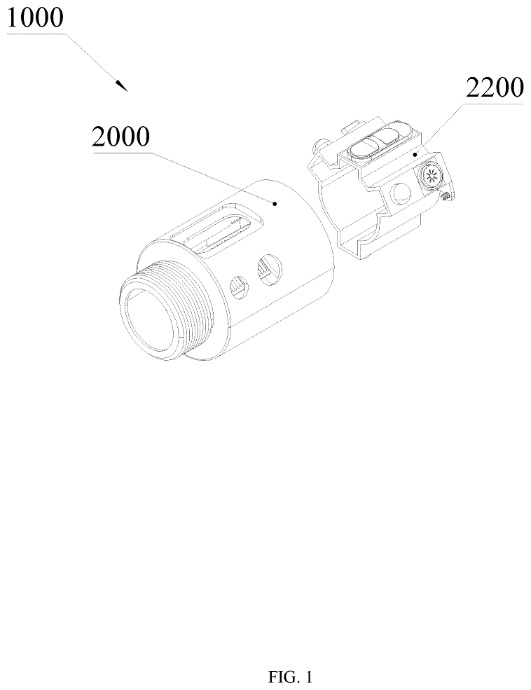

The invention provides an integrated infrared sensing device 1000 for controlling a light source, as shown in FIG. 1, comprising a housing 2000 and a mounting base 2200 arranged in the housing 2000.

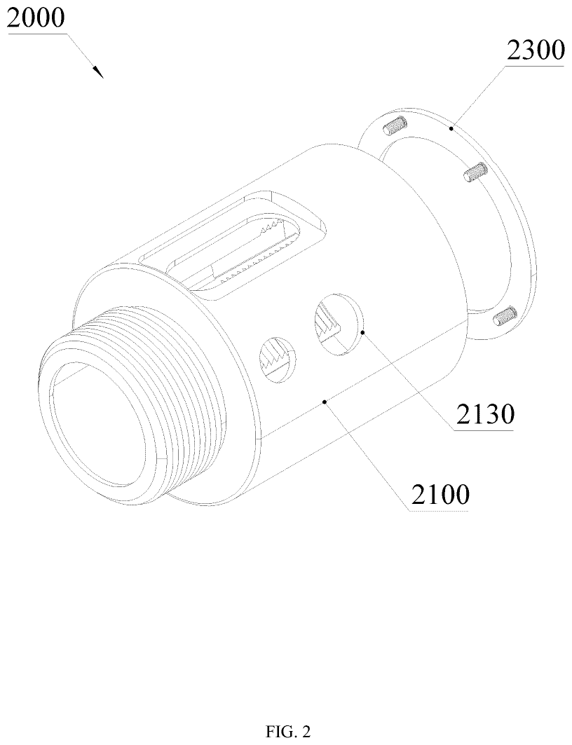

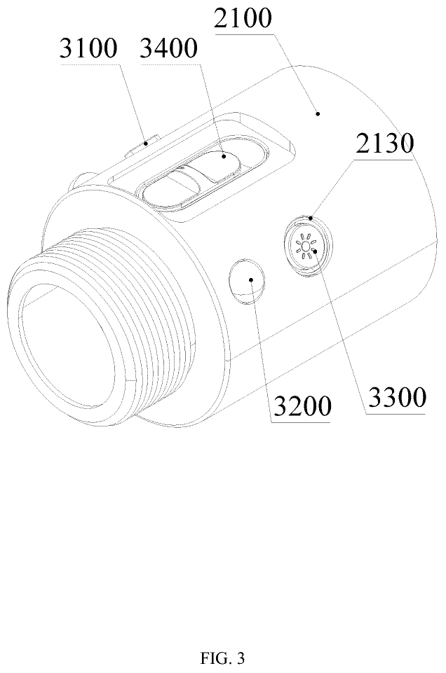

As shown in FIG. 2, the housing 2000 comprises a housing body 2100 and a ring 2300. The housing body 2100 is provided with a plurality of through holes 2130. In this embodiment, there are six through holes 2130, three of which are evenly distributed on an outer surface of the housing body 2100 in a circumferential direction, and the included angle between every two through holes 2130 is 120 degrees. As shown in FIG. 3, the three through holes 2130 evenly distributed in the circumferential direction allow infrared sensing probes 3200 to extend to the outside, and the other three through holes allow a brightness adjusting key 3300, a mode control key 3400 and a sensitivity adjusting key 3100 to extend to the outside. In other embodiments (not shown in the figure), seven, eight or more through holes 2130 can be provided on the housing body, depending on the number of the infrared sensing probes 3200 and the number of the adjusting keys.

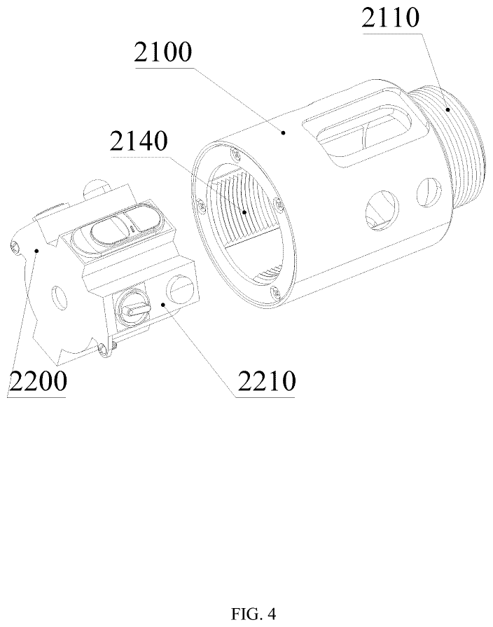

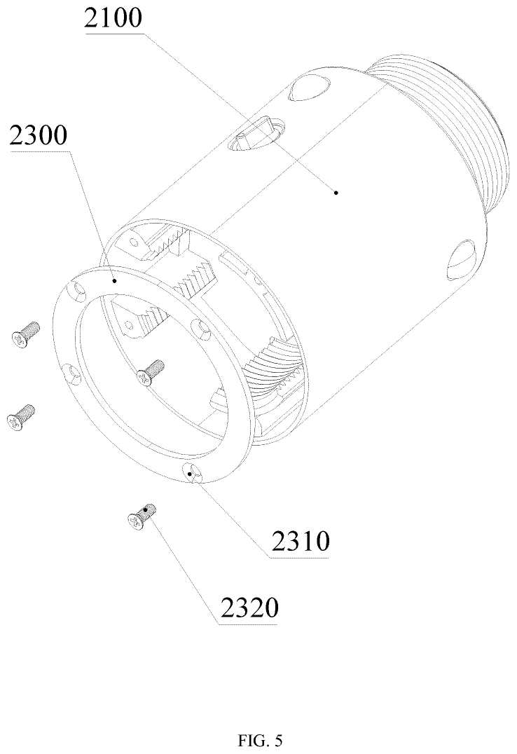

As shown in FIG. 4, connecting blocks 2140 are arranged in the housing body 2100, the connecting blocks 2140 and protrusions 2210 on the mounting base 2200 are arranged in a cross way, a lower part of the connecting block 2140 is provided with a threaded structure, the connecting block 2140 is fixedly connected with the mounting base 2200, and a top of the housing body 2100 is provided with an external connecting part 2110, which is provided with external threads for connecting with external equipment. As shown in FIG. 5, a ring 2300 is arranged below the housing body 2100, four screw holes 2310 are circumferentially formed in the ring 2300, and the ring 2300 is fixedly connected with the housing body 2100 through screws 2320, thus ensuring the integration of the device.

In other possible embodiments (not shown in the figure), a lower part of the housing body 2100 may also be provided with a bottom surface integrated with the housing body 2100, a through hole is formed in a center of the bottom surface, a connector for external connection can also be provided on the lower part of the housing body 2100, the connector and the housing body 2100 are fixedly connected through external threads on the connector and internal threads on the housing body 2100, and a lower surface of the connector also needs to be provided with an opening for wires to pass through.

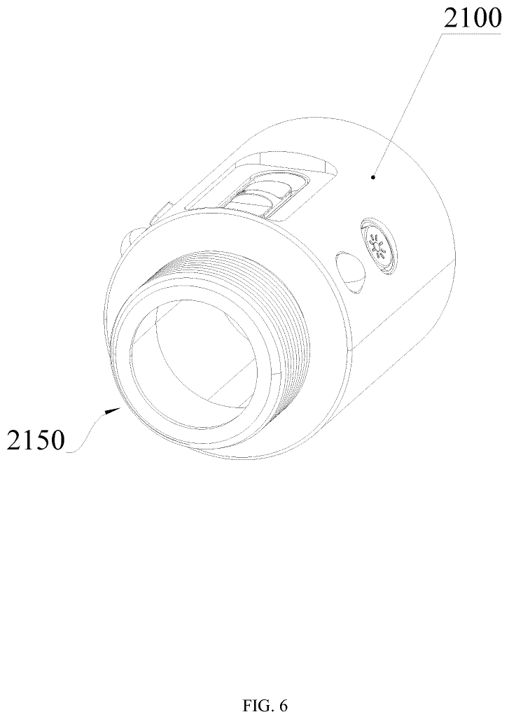

As shown in FIG. 6, in this embodiment, the housing body 2100 has a cylindrical surface, and a cavity 2150 is formed inside the housing body 2100. The housing body 2100 is made of a rigid material, such as iron, aluminum, aluminum alloy and stainless steel. In other embodiments (not shown in the figure), the housing body 2100 may also have a hexahedral surface and be made of an insulating material, such as PPS, PP and plastic. The choice of material depends on actual needs.

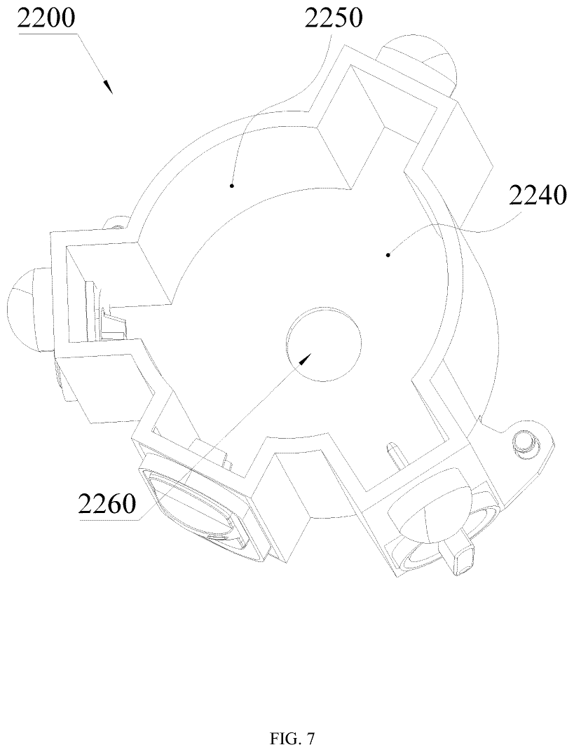

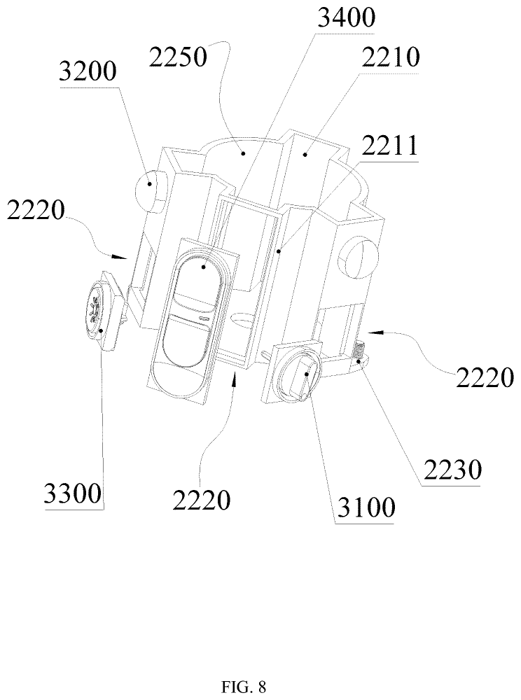

As shown in FIG. 7, the mounting base 2200 has a bottom surface 2240 and an outer wall 2250, the outer wall 2250 extends vertically upward from the bottom surface 2240, and a wire hole 2260 is formed in the bottom surface 2240, allowing wires to pass through. In this embodiment (as shown in FIG. 8), four protrusions 2210 are arranged on the outer wall 2250, three of the protrusions 2210 are evenly distributed in the circumferential direction, each of the three protrusions 2210 is provided with an infrared sensing probe 3200, and a fourth protrusion 2211 is arranged between two of the protrusions 2210; the fourth protrusion 2211 is provided with an opening 2220 on which a mode control key 3400 is installed, the protrusions 2210 at the left and right sides of the fourth protrusion 2211 are provided with openings 2220 and set screws 2230, and the set screws 2230 are fixedly connected with the connecting blocks 2140 arranged in the housing body 2100 through screws; and a sensitivity adjusting key 3100 is arranged on the opening 2220 of the protrusion 2210 on one side, and a brightness adjusting key 3300 is arranged on the opening 2220 of the protrusion 2210 on the other side.

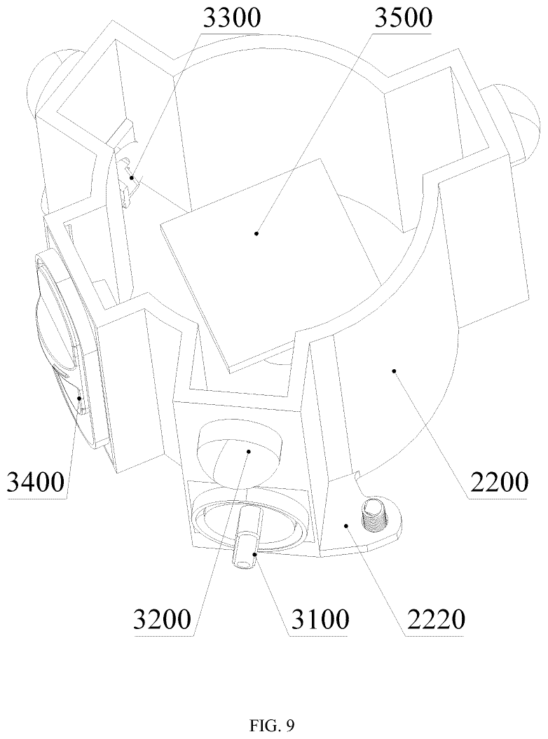

As shown in FIG. 9, a control circuit board 3500 is arranged in the mounting base 2200, and the sensitivity adjusting key 3100, the infrared sensing probes 3200, the brightness adjusting key 3300 and the mode control key 3400 are all electrically connected with the control circuit board 3500. The infrared sensing probes 3200 enable 360-degree sensing of humans or objects, the sensitivity adjusting key 3100 can adjust the sensing distance of the infrared sensing probe 3200, the brightness adjusting key 3300 can be adjusted to send an electrical signal to the control circuit board 3500, so that the control circuit board 3500 controls the brightness of the light source, and the mode control key 3400 can be adjusted to send an electrical signal to the control circuit board 3500, so that the control circuit board 3500 controls the integrated infrared sensing device 1000 to work in different modes.

A using method of an integrated infrared sensing device for controlling a light source is provided, comprising:
providing an integrated infrared sensing device 1000 for controlling a light source, the integrated infrared sensing device 1000 comprising a housing 2000 and a mounting base 2200, three infrared sensing probes 3200, a sensitivity adjusting key 3100, a brightness adjusting key 3300 and a mode control key 3400 being arranged on the mounting base 2200, and an external connecting part 2110 being arranged at a top of the housing 2000; wherein the infrared sensing probes 3200 enable 360-degree sensing of human activity within a sensing distance, and when there is human activity, the infrared sensing probes 3200 control the light source to emit light through electrical signals, otherwise, the light source is in a standby state.

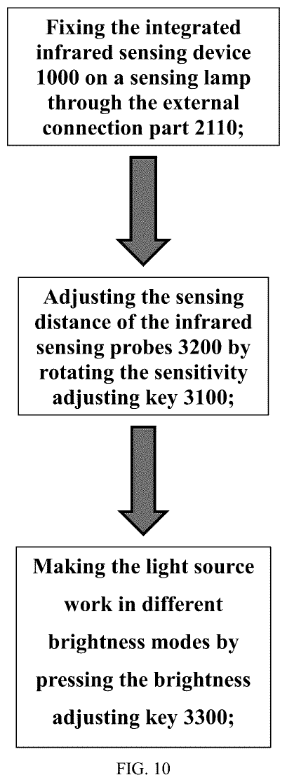

As shown in FIG. 10, the using method comprises:
fixing the integrated infrared sensing device 1000 on a sensing lamp through the external connection part 2110;
adjusting the sensing distance of the infrared sensing probes 3200 through the sensitivity adjusting key 3100; and
making the light source work in different brightness modes through the brightness adjusting key 3300.

The sensitivity adjusting key 3100 is able to adjust the sensing distance of the infrared sensing probes 3200 to 10 feet, 20 feet, 30 feet or maximum distance, and the maximum distance refers to the farthest range within which the infrared sensing probe 3200 can detect.

The mode control key 3400 is a sliding adjustment key that allows selection of three different operating modes for the integrated infrared sensing device 1000, namely test mode, AUTO mode, and Dusk To Dawn mode, with the test mode located in an upper position, the AUTO mode in the middle, and the Dusk To Dawn mode in a lower position.

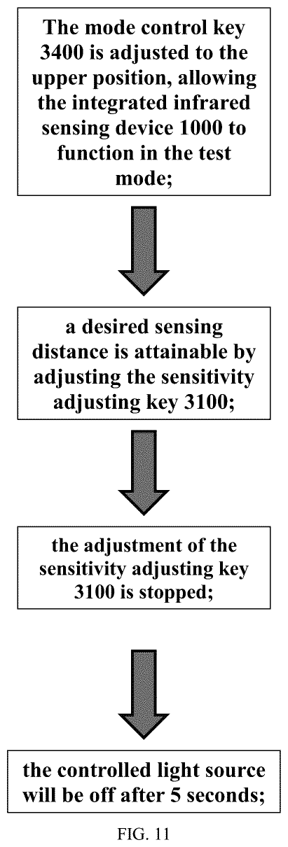

As shown in FIG. 11, the mode control key 3400 is adjusted to the upper position, allowing the integrated infrared sensing device 1000 to function in the test mode, a desired sensing distance is attainable by adjusting the sensitivity adjusting key 3100 regardless of day or night, and when the adjustment of the sensitivity adjusting key 3100 is stopped, the controlled light source will be off after 5 seconds.

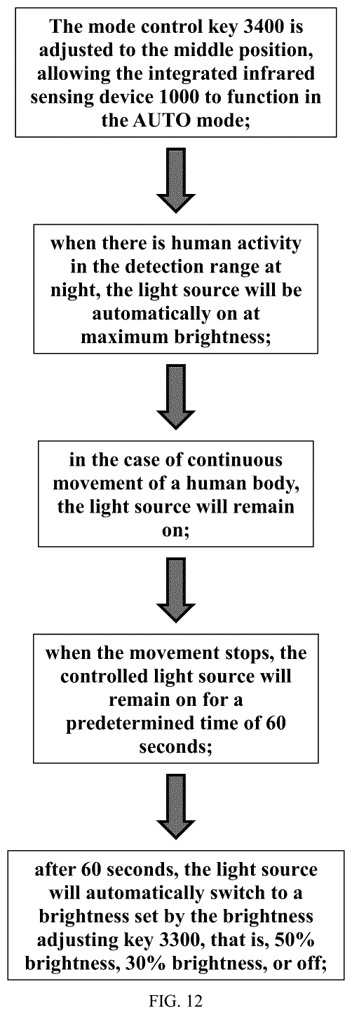

As shown in FIG. 12, the mode control key 3400 is adjusted to the middle position, allowing the integrated infrared sensing device 1000 to function in the AUTO mode; when there is human activity in the detection range at night, the light source will be automatically on at maximum brightness; in the case of continuous movement of a human body, the light source will remain on; and when the movement stops, the controlled light source will remain on for a predetermined time of 60 seconds, and after 60 seconds, the light source will automatically switch to a brightness set by the brightness adjusting key 3300, that is, 50% brightness, 30% brightness, or off.

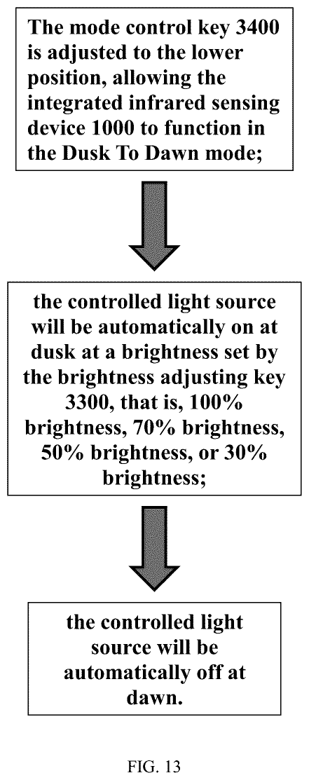

As shown in FIG. 13, the mode control key 3400 is adjusted to the lower position, allowing the integrated infrared sensing device 1000 to function in the Dusk To Dawn mode, the controlled light source will be automatically on at dusk at a brightness set by the brightness adjusting key 3300, that is, 100% brightness, 70% brightness, 50% brightness, or 30% brightness, and the controlled light source will be automatically off at dawn.

The technical means disclosed in the scheme of the invention are not limited to the technical means disclosed in the above embodiments, but also include technical schemes involving any combination of the above technical features. It should be noted that several improvements or embellishments made by those of ordinary skill in the art without departing from the principles of the invention should also be regarded as the scope of protection of the invention.

What is claimed is:

1. An integrated infrared sensing device for controlling a light source, comprising a housing and a mounting base arranged in the housing, wherein
a plurality of through holes are formed in the housing, a sensitivity adjusting key and at least one infrared sensing probe are arranged on the mounting base, and the sensitivity adjusting key and the infrared sensing probe are able to extend out of the through holes;
a control circuit board electrically connected with the sensitivity adjusting key and the infrared sensing probe is also arranged in the housing;
the infrared sensing probes enable 360-degree sensing of humans or objects;
the sensitivity adjusting key is able to adjust the sensing distance of the infrared sensing probe; and
the control circuit board controls the on/off of the light source after receiving a sensing signal from the infrared sensing probe.

2. The integrated infrared sensing device for controlling a light source according to claim 1, wherein a brightness adjusting key is arranged on the mounting base, the brightness adjusting key is electrically connected with the control circuit board, and by adjusting the brightness adjusting key, an electric signal is sent to the control circuit board, enabling the control circuit board to regulate the brightness of the light source.

3. The integrated infrared sensing device for controlling a light source according to claim 1, wherein a mode control key is arranged on the mounting base, the mode control key is electrically connected with the control circuit board, and by adjusting the mode control key, an electric signal is sent to the control circuit board, enabling the control circuit board to control the integrated infrared sensing device to work in different modes.

4. The integrated infrared sensing device for controlling a light source according to claim 1, wherein the housing comprises a housing body and a ring, and at least two through holes are provided and arranged circumferentially on an outer surface of the housing body.

5. The integrated infrared sensing device for controlling a light source according to claim 4, wherein the housing body is provided with a cylindrical surface, a cavity is formed inside the housing body, and an external connecting part is arranged at a top of the housing body.

6. The integrated infrared sensing device for controlling a light source according to claim 4, wherein the housing body is made of a rigid material.

7. The integrated infrared sensing device for controlling a light source according to claim 4, wherein the housing body is made of an insulating material.

8. The integrated infrared sensing device for controlling a light source according to claim 4, wherein the mounting base is provided with a bottom surface and an outer wall, the outer wall extends vertically upward from the bottom surface, a wire hole is formed in the bottom surface, at least two protrusions are arranged on the outer wall, and at least one of the protrusions is provided with an opening and a set screw.

9. The integrated infrared sensing device for controlling a light source according to claim 8, wherein the infrared sensing probes are arranged on the protrusions, and the sensitivity adjusting key, the brightness adjusting key and the mode control key are installed on the corresponding openings and extend out through the corresponding through holes provided on the housing body.

10. The integrated infrared sensing device for controlling a light source according to claim 4, wherein connecting blocks are arranged in the housing body, and the connecting block is able to extend into the space between two adjacent protrusions and be fixedly connected with the set screw, thus making the overall structure of the device more stable.

11. The integrated infrared sensing device for controlling a light source according to claim 4, wherein at least two screw holes are circumferentially formed in the ring, and the ring is fixedly connected with the housing body using screws, thus ensuring the integration of the device.

12. An integrated infrared sensing device for controlling a light source, comprising a housing, wherein
at least three infrared sensing probes and a sensitivity adjusting key are arranged on the housing, and a control circuit board electrically connected with the infrared sensing probes and the sensitivity adjusting key is arranged in the housing;
the infrared sensing probe enables 360-degree sensing of humans or objects;
the sensitivity adjusting key is able to adjust the sensing distance of the infrared sensing probe; and
the control circuit board controls the on/off of the light source after receiving a sensing signal from the infrared sensing probe.

13. The integrated infrared sensing device for controlling a light source according to claim 12, wherein the housing comprises a housing body and a ring, at least six through holes are circumferentially formed in the housing body, a mounting base is arranged in the housing, a brightness adjusting key and a mode control key are arranged on the mounting base, four protrusions are circumferentially distributed on an outer side of the mounting base, and three of the infrared sensing probes are evenly distributed in a circumferential direction and correspondingly installed on three of the protrusions.

14. The integrated infrared sensing device for controlling a light source according to claim 12, wherein at least two of the protrusions are provided with openings, the sensitivity adjusting key, the brightness adjusting key and the mode control key are installed on the corresponding openings and extend out through the through holes, and the ring is fixedly connected with the housing using screws.

15. A using method of an integrated infrared sensing device for controlling a light source, comprising:
providing an integrated infrared sensing device for controlling a light source, the integrated infrared sensing device comprising a housing, three infrared sensing probes, a sensitivity adjusting key, a brightness adjusting key and a mode control key being arranged on the housing, and an external connecting part being arranged at a top of the housing;
wherein the infrared sensing probes enable 360-degree sensing of human activity within a sensing distance, and when there is human activity, the infrared sensing probes control the light source to emit light through electrical signals, otherwise, the light source is in a standby state; and
the using method further comprising:
fixing the integrated infrared sensing device on a sensing lamp through the external connecting part;
adjusting the sensing distance of the infrared sensing probes through the sensitivity adjusting key; and
making the light source work in different brightness modes through the brightness adjusting key.

16. The using method according to claim 15, wherein the sensitivity adjusting key is able to adjust the sensing distance of the infrared sensing probes to 10 feet, 20 feet, 30 feet or maximum distance.

17. The using method according to claim 15, wherein the mode control key is a sliding adjustment key that allows selection of three different operating modes for the integrated infrared sensing device, namely test mode, AUTO mode, and Dusk To Dawn mode, with the test mode located in an upper position, the AUTO mode in the middle, and the Dusk To Dawn mode in a lower position.

18. The using method according to claim 17, wherein the mode control key is adjusted to the upper position, allowing the integrated infrared sensing device to function in the test mode, a desired sensing distance is attainable by adjusting the sensitivity adjusting key regardless of day or night, and when the adjustment of the sensitivity adjusting key is stopped, the controlled light source will be off after 5 seconds.

19. The using method according to claim 17, wherein the mode control key is adjusted to the middle position, allowing the integrated infrared sensing device to function in the AUTO mode; when there is human activity in the detection range at night, the light source will be automatically on at maximum brightness; in the case of continuous movement of a human body, the light source will remain on; and when the movement stops, the controlled light source will remain on for a predetermined time of 60 seconds, and after 60 seconds, the light source will automatically switch to a brightness set by the brightness adjusting key.

20. The using method according to claim 17, wherein the mode control key is adjusted to the lower position, allowing the integrated infrared sensing device to function in the Dusk To Dawn mode, the controlled light source will be automatically on at dusk at a brightness set by the brightness adjusting key, and the controlled light source will be automatically off at dawn.
